(19) United States
(12) Patent Application Publication
(10) Pub. No.: US 2007/0110378 A1
(43) Pub. Date: May 17, 2007

(54) Light-emitting form exhibiting an aura

(76) Inventor: James R. Zarian, Corona Del Mar, CA (US)

Correspondence Address: ELMAN TECHNOLOGY LAW, P.C., P. O. BOX 209, SWARTHMORE, PA, 19081, US

(21) Appl. No.: 10/567,076

(22) PCT Filed: Aug. 4, 2004
(86) PCT No.: PCT/US04/25221

§ 371 Date: Oct. 23, 2006

Related U.S. Application Data
(60) Provisional application No. 60/491,836, filed on Aug. 4, 2003.
(60) Provisional application No. 60/510,835, filed on Oct. 14, 2003.

(51) Int. Cl. G02B 6/02; G02B 6/032

(52) U.S. Cl. 385/125; 385/141

(57) ABSTRACT

A light-emitting form comprises an elongated light guide illuminated by a light source (10a) such as an LED that sheds light into the end of the light guide. The light guide comprises a tubular light-transmitting container (30) consisting essentially of a substantially amorphous polymer, and an elongated light-transmitting core (20), which may be liquid, with an index of refraction lower than the index of refraction of the container. The light guide exhibits an aura, wherein the outside surface of the container (30) illuminates its surroundings and appears to glow, rather like neon lighting tubes.

### TECHNICAL FIELD

The present invention broadly relates to a light-emitting form for transmitting and emitting light at one or more wavelengths. More specifically, the light-emitting form is elongated and can be tubular (cylindrical) simulating a linear light guide.

### BACKGROUND ART

Various lighting systems are known using light-emitting diodes (LEDs). LEDs have been the center of focus because of aesthetic, design flexibility, color changing, long life, small physical dimensions and other attributes that together advantageously serve the intended markets. LEDs as a source of light offer many advantages; moreover, their usefulness is enhanced by the use of optical elements, such as light guides, lenses, refractors, reflectors to disperse, reflect and refract light. As such, LEDs have been combined with various light conduits, such as so called “optical fibers”, “fiber optics”, “light pipes” and “light guides”, collectively categorized as light guides. These lighting systems find use in markets, such as sign, displays, architectural and transportation.

Light guides are normally made out of polymers, glass, metals or liquids. In particular, light guides, such as the ones disclosed in U.S. Pat. Nos. 5,052,778; 4,957,347; 6,278,827; 5,406,641; 5,485,541; 5,898,810 and 6,535,667 and others, are formed from an outer sheath or cladding and a polymer core. Invariably, a polymer of a relatively higher refractive index is used for the “core” and a relatively lower refractive index polymer is used for the “cladding”. Additionally, in general, the cladding polymers' molecular structures have fluorine moieties. The technical disclosure of each reference cited in the present patent disclosure is hereby incorporated by reference. Also, their cumulative teachings are deemed to constitute the knowledge of those skilled in the field of the present invention.

Another class of light guides, for example, as disclosed in U.S. Pat. Nos. 4,261,936 and 5,111,526, and having substantially smaller diameters compared to the above light guides, comprises of thermoplastic polymer core with a relatively higher refractive index than the cladding polymer. The cladding polymer's molecular structure has fluorine moieties.

Another type of light guide in the same category, U.S. Pat. No. 6,488,397, discloses a light guide with a strip of reflective material placed at the core-clad interface to disperse light. The core polymer has a relatively higher refractive index than the cladding. The cladding's molecular structure, however, does not contain any fluorine moieties. In such a light guide, the light dispersion is directional, and no aura is evident.

In yet another class of light guides, liquid light guides are disclosed. These light guides are normally formed from a thermoplastic cladding and a liquid core. Such liquid light guides fall in two main categories. The first category, mainly used in the medical industry, and intended to transmit light from one point (input or proximal end) to the end point (output or distal end), for example, as disclosed in U.S. Pat. Nos. 5,452,395, 6,418,257 and 6,507,688. The manufacturing processes for the production of this class of light guides is rather specialized and cost-prohibitive for many applications. Normally, a very concentrated salt solution with a higher refractive index forms the liquid core, which is contained in polymer of lower refractive index. In the second category, for example, as disclosed in U.S. Pat. Nos. 5,799,124 and 5,896,483, illuminating systems for decorative applications are presented. In the latter category, the cladding also has a refractive index lower than the core.

In general, the light guides mentioned above have been designed to create a particular effect, for example, to create a “neon effect.” Neon tubing, a commonly known lighting medium, glows from the sides when activated and commonly has a pronounced aura. This effect is known as neon effect. The light guides disclosed in the U.S. Pat. Nos. 5,052,778, 4,957,347, 6,278,827, 5,406,641 and 5,485,541, 5,799,124, 5,898,810 and 6,535,667 in part, imply and disclose such light guides.

In seeking to more closely resemble the glow and aura of neon, using light guides, various means have been devised. U.S. Pat. No. 5,067,831 (herein '831) describes the general concept of the side scattering light guides. '831 discloses a polymer core having a higher refractive index encased within a transparent fluoropolymer cladding having a lower refractive index. '831 relies on the leakage of light from the cladding through a jacketing to achieve the intended goal.

U.S. Published Patent Application 2002/0131275A1 (herein '275) uses an “illuminating device that includes a light-guiding member formed of a translucent material” having “a light-emitting region along the length of the light-guiding member; and a plurality of grooves having a rectangular cross-section and formed in the circumferential surface of the light-guiding member at appropriate intervals in the axial direction.” '275 does not disclose the use of any cladding.

U.S. Pat. No. 4,733,332 discloses the use of “optical facets or fine powder” on one side of the core. The fine powder is disclosed as having a refractive index higher than the core, the core yet having a relatively higher refractive index than the cladding. U.S. Pat. Nos. 5,982,969 and 6,169,836, in a similar fashion, allude to the use of fine particles in a higher-refractive-index core and lower-refractive cladding to disperse light in a predetermined manner to emulate a linear light form.

U.S. Pat. No. 6,488,397 (herein '397) discloses a method to disperse light by “at least one strip-shaped reflecting layer formed by printing on the side surface of the light transmission” core “having a high reflective index”. '397 does not disclose the refractive index of “protective sheathing.” Similarly, U.S. Pat. No. 6,550,952, and herein incorporated by reference, discloses a method to disperse light from a “light pipe”, which has a higher refractive index core and a lower refractive index cladding by inventive steps as disclosed therein.

Japanese Patent JP08-094862A discloses a transparent core encased within a fluoro-rubber cladding. The fluoro-rubber cladding contains particles such as activated carbon, silica, silica gel, alumina or molecular sieve, zeolite-based absorbent, ion exchange resin, magnesium oxide, calcium carbonate or silver sulfate to trap halogen compounds. By trapping halogen compounds the aforementioned particles stabilize the cladding against a decrease in transmission due to halogen compounds. However, as disclosed therein, the concentration of the aforementioned particles is higher than the optimum level of effective light enhancement and the particles therefore contribute to opacity.

U.S. Pat. No. 4,422,719 (herein '719) discloses a transparent semi-solid core which is encased within a tubular cladding. '719 discloses the following ways of providing side-scattering capability: “Scoring the surface of the cylindrical core with angular cuts or discontinuities.” However this is an expensive and inconsistent method. “Introducing bubbles or foreign materials into the cylindrical core material while the cylindrical core is still molten.” The molten state is not well defined, and like similar art, the bubbles and foreign materials contribute to non-uniform and excessive absorption of light. “Introducing powder into the tubular cladding material. For example, titanium dioxide (TiO₂) is present in the cladding material at levels in the order of 2-10%.” Similar to the immediate method described above, foreign materials contribute to excessive absorption of light and actually block the transmission of light from the transparent cladding. “Forming the tubular cladding from a material which has an index of refraction exceeding that of the cylindrical core.” This method is not well defined and the preferred cladding material, polychlorinated poly phenyl, does not readily form into a tubular cladding and typically has a very yellow appearance. Ambiguity of '719, in the latter method, does not provide for an advantageous method to achieve the objectives as disclosed.

U.S. Pat. No. 6,091,878 (herein '878) limits the concentration of additives which are added to the tubular cladding to increase the effectiveness with which light is transmitted circumferentially out of a cylindrical light guide. While '878 addresses some of the deficiencies of '719, the light guides of '878 suffer from a lack of efficiency due to the large angles at which light is scattered by the aforementioned additive. The light guides of '878 along with '719 also require additional manufacturing steps for their formation. For example, one of the methods of '719 requires the formation of angular cuts or discontinuities and the light guides of '878 require the introduction of additives into the tubular cladding.

U.S. Pat. No. 5,937,127 (herein '127) in general discloses a linear light form, or more specifically a light conduit whereby the overall illuminated diameter of the conduit is maximized while the overall illuminated diameter of light transmitting component is minimized. The advantage disclosed is that it “exhibits a larger illuminated diameter using the aura effect” utilizing “conventional thermoset cores and cladding having optimized cross-sectional diameters” to ensure energy efficiency and reduce the cost of production. '127 achieves this objective by utilizing and applying multiple layers of jacket materials onto “the outer periphery of fiber optic core and cladding, to expand the perceived size of the fiber optic core and cladding.” '127 further discloses advantages such as to provide: “a conduit that, when bent, does not exhibit a hot spots a conduit illuminated generally uniformly across it length; a conduit exhibiting a higher uniformity and a larger appearance in outside diameter; and most importantly a conduit with a perceived “aura”. '127's manufacturing process, nonetheless, uses combination of materials, uses “multiple layers . . . of polymeric jackets” and has numerous steps as disclosed therein, making the light conduit very costly to produce. '127, nonetheless, claims to have an aura, a very desirable effect. “Aura” is defined as luminous radiation. The “aura effect” is where luminous radiation appears outside of the core and cladding, and is visible in the space surrounding the linear light form. '127 further points to “bend radius”, and hot spots, disclosing it as follows: Linear light forms, when bent past a certain degree known as permissible “bend radius,” appear to have a “hot spot.” A hot spot is defined as the area of the optic that appears to be brighter than the rest of the optic. The hot spots can detract from lighting applications wherein the uniformity of the light is desirable. It is thus desirable to reduce the hot spot effect.

U.S. Pat. Nos. 5,987,199 and 6,289,150 (herein '199 and '150) disclose another elaborate method to create light forms with sufficient light to illuminate an area surrounding the linear light form. The light forms according to '199 and '150 nonetheless are very directional and extend to short distances. In summary, the light forms disclosed are a variation of thermoset of relatively higher refractive index and a lower refractive index cladding, manipulated and placed in a channel to reflect the light. The combination of the cuts and the reflection of light off the channel hinder the efficiency of the light form.

In almost all of light forms such as fiber optics, light guides, light pipes and light conduits or similar modalities which would be considered as light forms, they are mainly composed of a core and a cladding. The core is the light-transmitting medium and the cladding is the immediate layer in contact with the light-transmitting medium that in combination provide total internal reflection useful in light forms. Further, the core has a higher refractive index and the cladding has a lower refractive index. In most of the light forms, the cladding molecular structure contains fluorine atoms. Fluorinated or fluorine-based molecular structures inherently provide a relatively lower refractive index. Fluorinated polymers with backbones other than carbon, such as silicone, have also been used. However, fluorinated and fluorine-containing polymers are costly and difficult to process.

The light forms discussed above, in combination with light sources such as halogen, xenon, high intensity discharge lamps or LEDs, have been used to create illumination systems seeking to solve the problems associated with traditional neon light systems. However, the light guides discussed above, due to the relatively high cost of raw materials and their corresponding manufacturing processes, are relatively expensive and limited in their applications. There is a need for light forms which can be formed from relatively less expensive raw materials and less costly processes, and can be used in a wider range of applications than known light guides.

It is therefore desirable to provide an elongated side-glowing light form with substantial aura that is an alternative to those disclosed in the above-referenced patents. It is also desirable to provide an effective method of manufacturing such an alternative side-glowing light from.

### DISCLOSURE OF INVENTION

The present invention relates to light-emitting forms comprising a light transmitting medium (core) of lower refractive index encased in a container (cladding) of a higher refractive index, whereby the light form, when illuminated, glows uniformly and has an aura. Although the core has a lower refractive index and thus does not cause total internal reflection, however it has been discovered to contribute to light transmission. In an embodiment where there was no core or core was of a lower purity, we observed either very small lateral transmission or an immediate drop off in light transmission.

In accordance with an important aspect of the invention, a light form of the present invention, when illuminated, glows uniformly and has an aura. Aura is the luminous radiation which appears outside the light form and is visible in the space surrounding the light form and can illuminate an object substantially away from the light form.

In accordance with one aspect of the invention, the light-transmitting core may be a liquid, monomer, substantially amorphous oligomer(telomer), prepolymer, polymer and/or combination thereof, or a mixture of oligomers and/or polymers in a solution. As used in this patent disclosure, “substantially amorphous” polymers and oligomers would have less than 5 wt. % crystallinity as measured by DSC (Differential Scanning Calorimetry). For preferred embodiments of the present invention, such substances would have preferably less than 1 wt. % and most preferably less than 0.1 wt. % crystallinity.

In accordance with another aspect of the invention, the liquid core is advantageously selected from oils, salt solutions, water-soluble polymers, water solution of water-soluble polymers, organic compounds of lower molecular weight, solution of low molecular weight organic and/or inorganic compounds, monomers, oligomers, prepolymers and polymers in organic and inorganic solvents.

In accordance with yet another aspect of the invention, the oligomer core is advantageously selected from oily oligomers, oligomers of water-soluble polymers and copolymers, substantially amorphous oligomers of esters, carbonates, acetals, amides, acrylamides, vinyl ethers, vinyl acetates, vinyl esters, acrylic acids, acrylates, methacrylates, allyl esters, styrenes, and adipates.

In accordance with another aspect of the invention, the prepolymer or precursor of the core is advantageously selected from prepolymer of water-soluble polymers and or copolymers, substantially amorphous prepolymer or pre-copolymer of esters, carbonates, acetals, vinyl ethers, vinyl acetates, vinyl esters, acrylic acids, acrylates, methacrylates, allyl esters, styrenes, adipates and silicones. Additionally the prepolymer as a precursor may be predetermined to be converted to a thermoplastic or thermoset polymer in situ.

In accordance with another aspect of the invention, the polymeric or copolymer core is advantageously selected from thermoplastic or thermoset classes. The thermoplastic class is selected from the substantially amorphous esters, carbonates, acetals, amides, acrylamides, vinyl ethers, vinyl acetates, vinyl esters, acrylic acids, acrylates, methacrylates, allyl esters, styrenes, and urethanes. The thermoset is selected from the class of substantially amorphous esters, carbonates, acetals, amides, acrylamides, vinyl ethers, vinyl acetates, vinyl esters, acrylic acids, acrylates, methacrylates, allyl esters, styrenes, and adipates.

In accordance with another aspect of the invention, the core medium is purified by filtration, distillation, use of molecular sieves, use of centrifugal force, crystallization and/or combinations thereof.

In accordance with another aspect of the invention, the liquids, oligomers, prepolymers, polymers and copolymer of the core and/or in combination with other precursors are advantageously poured, pumped or vacuumed into the cladding. Typically it is not necessary to limit the temperature, pressure or combination thereof, used at the time of processing.

In accordance with an aspect of the invention, the precursor of the thermoplastic polymer or copolymer core has been prepared prior to the placement into the container. The precursor, in accordance with an important aspect of the invention, has a syrupy consistency and is capable of being further polymerized to a more completed, polymerized state. The precursor may advantageously be poured, pumped, vacuumed into the cladding and polymerized in situ.

In accordance with an aspect of the invention, the thermoset polymer core may advantageously be made of cross-linking ingredients, and placed into the container and cross-linked in situ.

In accordance with an important aspect of the invention, the raw materials for the core, is less costly and easier to process in comparison to prior art.

In accordance with an aspect of the invention, the container has advantageously been selected from a material that is substantially amorphous, translucent or transparent and, when illuminated, in combination with the appropriate core material, glows uniformly across its entire length and has an aura.

In accordance with an aspect of the invention, the container is advantageously selected from a material that is substantially amorphous, translucent or transparent and, when illuminated, in combination with the appropriate core material, glows uniformly and has an aura. Aura being the luminous radiation which appears outside and visible in the space surrounding the light-emitting form and being substantial to illuminate an object substantially away from the light-emitting form.

In accordance with an aspect of the invention, the container material may be formed from commercially available substantially amorphous polymers and or copolymers, such as substantially amorphous polyesters and may be free of halogens; or commercially available polymers and/or copolymers of silicones.

In accordance with an aspect of the invention, among the halogen-free polymer or copolymer are substantially amorphous polycarbonates, polyacetals, polyamides, polyacrylamides, polyvinyl ethers, polyvinyl acetates, polyvinyl esters, polyacrylic acids, polyacrylates, polymethacrylates, polyallyl esters, polystyrenes, polyadipates and silicones.

In accordance with an aspect of the invention, the cladding is a substantially amorphous halogenated derivative of polycarbonates, polyacetals, polyamides, polyacrylamides, polyvinyl ehters, polyvinyl acetates, polyvinyl esters, polyacrylic acids, polyacrylates, polymethacrylates, polyallyl esters, polystyrenes, polyadipates and silicones.

In accordance with an aspect of the invention, substantially amorphous silicon polymers, copolymers, blends and/or derivatives are used for the cladding.

In accordance with an aspect of the invention, the container is formed by commonly known processes, such as casting, vacuum forming, extrusion, blow molding, and injection molding.

In accordance with an aspect of the invention, the container is formed into long cylindrical tubes with a uniform cross section, providing a form such as light guides, optical fibers and fiber optics.

In accordance with an aspect of the invention, the tubular container has cross sections other than round.

In accordance with an aspect of the invention, the tubular container has an asymmetric cross section.

In accordance with an aspect of the invention, the container is soft or rigid and/or formable.

In accordance with an aspect of the invention, the light-emitting medium is combined with at least one light-emitting diode (LED), a power source and a switching and/or controlling device (light-emitting element) to form a self contained illumination device.

In accordance with an important aspect of the invention, the light-emitting element is immersed in the core material.

In accordance with an important aspect of the invention, the light-emitting element is attached to the core material.

### BRIEF DESCRIPTION OF DRAWINGS

FIG. 1 is a transverse cross-sectional view of a light-emitting form of the present invention showing different pathways of light in the core and container due to refraction and reflection.

FIG. 2 is a view similar to FIG. 1, except that in the embodiment illustrated in FIG. 2, the size of the light source is smaller than the size of the core, and therefore the only way light reaches the container is by refraction at the core/container interface.

FIGS. 3a to 3e each show a cross-sectional view of an embodiment of the present tubular light-emitting form having a cross section other than round.

### MODES FOR CARRYING OUT THE INVENTION

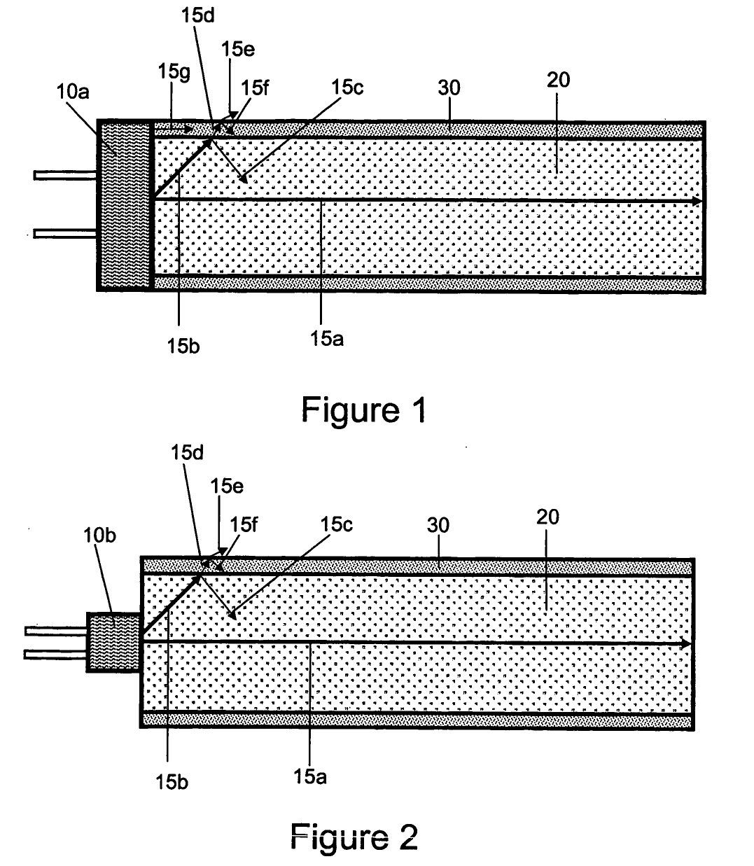

The present invention relates to light-emitting forms and illumination systems. The light-emitting form includes a container, which acts as an outer cladding, and a core material. In accordance with the present invention, the core has a lower refractive index and the cladding has a higher refractive index; additionally, the present light form, in combination with a light-emitting element such as a light-emitting diode, glows substantially uniformly across its length and has an aura. This is diagrammatically depicted in FIGS. 1 and 2.

FIGS. 1 and 2 are each a transverse cross-sectional view of a light-emitting form of the current invention. The light form comprises three important components, a light source 10a or 10b (which may be an LED), a core 20 with a refractive index n1, and a container that is optically connected to the core and has a higher refractive index n2, i.e. n2>n1. The difference between the embodiments of FIG. 1 and FIG. 2 is in the light source. FIG. 1 illustrates Example 3, below, where light source 10a corresponds to the LED 2MDR01-85R1A with diameter of about 8.5 mm and viewing angle of about 17°.

FIG. 2 corresponds to Examples 1 and 2, wherein light source 10b is exemplified by Agilent LED (HLMT-PG00), which has diameter of about 2 mm and a viewing angle of about 125°.

As shown in FIGS. 1 and 2, a light source 10a or 10b generates light rays, shown here by two examples, ray 15a and ray 15b. Light ray 15a travels along the axis in the core, which in accordance with the present invention has a lower refractive index than the container which serves to clad the core. Light ray 15b travels off-axis in the core and suffers refraction and reflection at the core/clad interface. Reflected light ray 15c travels away from the core/clad interface into the core. Refracted light ray 15d travels into the clad. Light ray 15d again suffers refraction and reflection at the clad/air interface. Refracted light ray 15e emits out of the clad and gives the effect of aura. Reflected light ray 15f generated at the clad/air interface will travel in the clad by internal reflection. Light ray 15g in FIG. 1 travels axially in the clad.

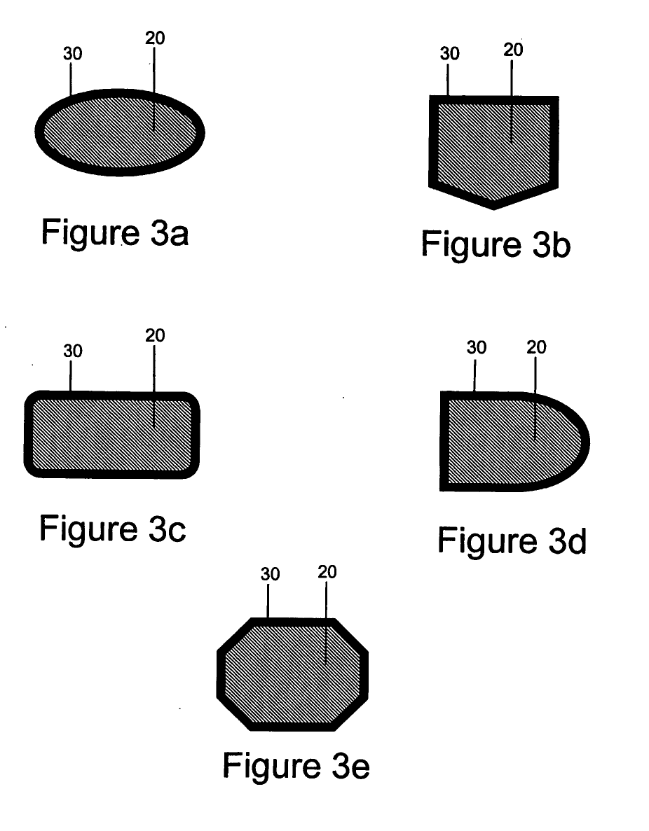

FIGS. 3a to 3e each show a cross-sectional view of the tubular light-emitting form of the present invention, as embodied having cross sections other than round. Each of these cross-sectional views shows core 20 with refractive index of n1 and container 30 (i.e. clad) with refractive index of n2, where n2 is greater than n1.

“Uniform glow” is a characteristic of preferred embodiments this invention. Such elongated light forms have a substantially uniform glow from one end to the other end of the light form over a substantial length. The length may be less than 0.5 meter to more than 10 meters. “Aura” relates to light emanating from the light form that can illuminate objects in proximity to the light form. For the purposes of this invention, aura exists when the emanating light is adequate to make visible an object that is at a distance from the light form of up to five times the diameter of the light form. For instance, an object placed 5 cm away in any direction from a 1-cm-diameter light form should be substantially illuminated and visible. In another way of explanation, at least 10% and preferably 50% of the light intensity at the surface of the light form is measurable at a distance five times the diameter.

Prior light forms did not offer such capability, until those disclosed in U.S. Pat. Nos. 5,937,127; 5,987,199 and 6,289,150. However, those light forms also required a very intense, yet very inefficient light source such as a halogen or high intensity discharge lamp.

For example, in one of the embodiments of the present invention, the core may be formed from liquid materials such as dimethyl cyclic siloxane, a “silicone oil”, with a refractive index of 1.395-1.397 and a container composed of a polyadipate such as an ether-based polyurethane with a refractive index of 1.5-1.6. The cost of the core raw materials associated with such a combination is advantageously low. Further, the use of a silicone-based material substantially reduces the flammability of the light form.

Another advantage of the present invention is realized in the cost of materials and cost of production. Known light guides, as disclosed in U.S. Pat. Nos. 4,261,936, 5,111,526, 5,052,778, 4,957,347, 5,406,641 and 5,485,541, function similarly, although not as efficiently, compared to the light-emitting form in accordance with the present invention; however, the cost of raw materials is much higher. Additionally, the cost of manufacturing is much higher due to the capital costs and labor associated with the processes. The advantage of the present invention is particularly more pronounced for light-emitting media with high volumes (e.g, mass volume), such as a container with a diameter of 5 mm and larger.

As an important aspect of the invention the core of the light-emitting medium may be a liquid, oligomer (telomer), prepolymer, polymer, copolymer and/or combinations thereof, or mixtures of oligomers and/or polymers in a solution.

Various liquids are contemplated for use as the core with the present invention. Exemplary liquids suitable for the present invention include oils such as, mineral oils, fluorinated oils, silicone oils; or liquids in the form of salt solutions, such as aqueous solution of inorganic salts (i.e. sodium chloride or potassium sulfate), aqueous solution of organic salts (i.e. potassium esters).

Another advantage of certain core materials of the present invention is realized by the aqueous mixture ingredient possibilities, which can render the light system more user-friendly, environment-friendly, non-inflammable and at least partially biodegradable.

Another class of liquids suitable for the present invention is the class of water-soluble polymers such as polyglycols. Polyglycol P425 supplied by Dow Chemical Co. (Midland, Mich.) purified in neat form, resulted in satisfactory result. Water solutions of the same compound, in ratios ranging from less than 1% to 99.9%, also are suitable. For example, Polyglycol P425 reportedly having a refractive index of 1.447 was combined as core with a polyadipate tubing with a refractive index of 1.5-1.6 as cladding to create a suitable light form according to the present invention.

Any derivatives, forms, combinations of the water-soluble polymers including, water-soluble salts, anionic, cationic, nonionic, cross-linked (hydrogels) and non-cross-linked, modified and unmodified species combined and derived from monomers, pre-polymers, polymers, co-polymers are contemplated and may be used according to this invention.

Any derivatives, forms, combinations of the polymers including, salts, anionic, cationic, nonionic, cross-linked (hydrogels) and non-cross-linked, modified and unmodified species combined and derived from monomers, pre-polymers, polymers, co-polymers in non-aqueous solvents are contemplated and may be used according to this invention.

Conversely, lower molecular weight organic compounds such as ethylene glycol, propylene glycol, benzene, methanol, ethanol, which all have a lower refractive index compared to polyadipate, if selected as core material, proved suitable.

Solution of oligomers of propylene glycol in propylene glycol, oligomers of methyl methacrylate in methyl methacrylate, oligomers of styrene in methyl methacrylate also proved suitable as core material n practicing the present invention, when using polyadipates (cladding) with a relatively higher refractive index.

Liquid prepolymers or syrupy polymers of materials such as methyl methacrylates, 2-ethylhexyl methacrylates, styrene, 2-ethylhexyl acrylate proved suitable for the present invention. Similarly, liquid solutions of poly(2-ethylhexyl methacrylate) in methyl methacrylate, in benzene, in methyl ethyl ketone 5 and in pentene, by the way of example, also proved suitable. For instance, by purifying and de-airing the core medium (e.g. removing any air or other gaseous matters from the core medium under low pressure prior to placing the core medium in the cladding), satisfactory light forms were prepared in accordance with the present invention. U.S. Pat. Nos. 4,108,923; 4,077,755; 3,966,693; and 3,907,727 among others disclose methods as bow a syrupy mixture of polymer or copolymer may be prepared.

When polymeric cores better suited an application, prepolymers proved useful as precursors for the production of such polymeric cores. In one instance, a prepolymer of 2-ethylhexyl methacrylate, in very pure form was combined with appropriate initiator and injected into a suitable cladding (i.e. polyadipate cladding), and further cured at a higher temperature in a water bath. The resulting light-emitting form was satisfactory. Use of prepolymers as a precursor is highly desirable for many reasons including, but not limited to, low shrinkage upon further polymerization and ease of placement into the cladding. Contrarily, according to U.S. Pat. Nos. 4,261,936, 5,111,526, 5,052,778, 4,957,347, 5,406,641 and 5,485,541, there is a high chance that bubbles can form or the polymer mass degrade because of highly exothermic polymerization reaction temperatures. Problems also ensue due to excessive shrinkage upon polymerization. Other polymerization methods such as emulsion and solution will result in non-transparent masses, which is not conducive to the objectives of the present invention.

Other Desirable Core Polymers Are:

Polyester plasticizers

Poly hydric alcohols, Poly alcohols, Polyols (e.g. Polyethylene glycols, Polypropylene glycol, Polyglycol distearates)

Polypropylene adipate

Polysilane

Polysiloxane (e.g. Polydimethylsiloxane)

Unique properties of crosslinked polymers may also prove desirable at times for both core and cladding. For instance, among the more desirable properties of crosslinked polymers is resistance to high temperature, less infusibility and less impermeability to moisture and undesirable gases. Crosslinked polymeric cores may be prepared utilizing appropriate prepolymers or monomer mixtures. In preparing a cross linked core, prepolymer of methyl methacrylate was combined with 0.1 to 1% by weight of diethylene dimethylmethacrylate, as a cross linker, prior to placement in a suitable cladding and cured, to obtain satisfactory results. The cladding used was a polyadipate (i.e. an ester based polyurethane), which had a higher refractive index than the completely polymerized, crosslinked core.

It is contemplated that crosslinked claddings can be used to form light forms according to the present invention. Any of the core materials as disclosed above are contemplated to prove useful in producing light forms using cross linked cladding materials according to the present invention, provided that the core material has a lower refractive index in comparison to the cross linked cladding.

Another way to prepare desirable polymeric cores is to use monomers as a precursor. Some of the advantages, but not limited to, are relatively lower monomer mixture viscosity, fewer processing steps and raw material cost. In one embodiment, highly purified 2-ethylhexyl methacrylate was combined with Trigonox ADC (e.g. peroxydicarbonate mixture) initiator, supplied by Akzo Nobel of Dobbs Ferry, N.Y., and injected into an ester-based polyurethane tubing; the tubing was capped at one end, kept on a roll, under pressure, in a cold compartment to avoid premature initiation and polymerization. The capped end of the tubing, while pressurized, was introduced into a hot water bath at a constant rate to initiate polymerization. A substantial length was polymerized in this manner; although, some of the tubing was wasted as the polymerizing monomer mixture shrank upon polymerization and was forced toward the capped end. In this manner, a progressive and continuous method of production was established. Although, it is contemplated that by continually introducing monomer mixture into the tubing the problem of the waste would be alleviated; nonetheless, the resulting composition was satisfactory. It is further contemplated that co-polymer or crosslinked polymer cores can be produced by selecting appropriate precursor monomer mixtures according to this method of production.

In another method, for example, n-butyl methacrylate was fully polymerized using an appropriate amount of Trigonox ADC as the initiator, at high temperature, under pressure in a closed system. The polymer mass, while kept molten, was then put under negative pressure, for an extended time, to remove any unreacted initiator, monomer or other volatiles. The molten mass was then injected into a polyurethane tubing kept at a high temperature, in a hot oil bath, to facilitate the flow of the polymer. The combination of core/cladding was then removed from the bath and allowed to cool to room temperature. Effectively, a polymer mass as core material with a lower refractive index was introduced into a cladding material with a higher refractive index. The light form was satisfactory for the purposes of this invention, and this method of production can be practiced according to this invention; although it is not clear if such a process is commercially cost effective.

Hydrogels, for example, as disclosed in U.S. Pat. Nos. 3,947,401; 4,450,262; 4,540,743; 4,492,776; 4,640, 965; 4,694,037, offer another class of core materials. In general, the referenced patents disclose methods for cross-linking water-soluble monomers, pre-polymers and copolymers and/or combinations thereof into hydrogels. The cross-linking may be done in situ with the appropriate crosslinkers. It is contemplated that crosslinking may be undertaken by different methods, for instance, heat may be used to initiate the reaction, or methods such as UV curing as disclosed in U.S. Pat. Nos. 5,010,141, 5,532,287 and 5,955,242, among other methods. It is also noted that UV-curable hydrophilic pre-polymers and polymers and water-swelling polymers may also be used. For example, silicone-containing hydrogels, or derivatives thereof such as the ones disclosed in U.S. Pat. Nos. 4,640,941, 5,010,141, 5,387,632, may be used as long as the refractive index of the resulting hydrogel is lower than the refractive index of the cladding.

UV-cured polymers offer another class of materials for the formation of the core.

Room-temperature-vulcanized (RTV) polymers offer another class of materials for the formation of the core.

Additionally, the core compositions of the present invention conveniently allow inclusion of light dispersing agents such as glass or metal flakes, fluorescing, frequency shifters, micro-bubbles among others if desired.

In order to enhance the dispersion of light, dispersing agents may be introduced either into the core material or into the cladding at various stages of production. In one exemplary embodiment of the present invention, 0.015 Hex/VM 2000 Glitter provided by 3M Company (St. Paul, Minn.) was mixed in a transparent viscous liquid of polysiloxane and injected into a suitable tubing. A 100-cm light-emitting device lit at each end by an LED supplied by Kingbright, Inc. (Walnut, Calif.) exhibits a dazzling, yet uniform illumination.

In many known light forms such as light guides as disclosed in U.S. Pat. Nos. 5,052,778 and 4,957,347, cladding materials with a relatively lower refractive indices are used. For instance, fluoropolymers and silicones, which inherently have lower refractive indices are used. These class of materials has a higher raw material cost and are costly to process. Fluoropolymers' relatively higher specific gravity, additionally, exacerbates their shortcomings. In order to overcome these shortcomings, the cladding wall thickness has been made very thin and substrates surrounding the fluoropolymer, devised, '831. Such systems suffer in many areas. For instance, in the course of polymerization of the core according to '831, the high shrinkage of the polymerizing mass causes the fluoropolymer cladding to collapse resulting in a non-uniform cross section. Further, the high shrinkage causes the core to separate from the fluoropolymer (de-lamination), leaving a gaps. The gaps appear as dark spots when the light guide is lit. The latter led to the use of heat shrink tubing, which, in turn, introduced more steps in the production of the light guides. The present invention obviates these shortcomings by using substantially amorphous polymers such as polyacrylamides, polycarbonates, polyvinyl acetates, polyvinyl ethers, polymethacrylates, polyacrylates, polyadipates, among other suitable materials that; although have a higher refractive index, are less costly, have lower specific gravity and relatively lower processing costs. These transparent, formable materials are also much more environmentally friendly.

In another aspect of the present invention, the cladding or container of the light form is not limited to a circular cross-section, which simplifies overall production. Claddings or containers are contemplated with circular as well as noncircular symmetric and asymmetric cross-sections, which do not require complicated processing. In contradistinction, U.S. Pat. Nos. 5,052,778, 4,957,347, 4,261,936 and 5,111,526, require that the core cross section to be essentially limited to circular. Known light guides with noncircular cross-sections, such as disclosed in U.S. Pat. Nos. RE 36,157; 4,957,347 and 5,052,778 require a series of rather complicated and cumbersome processes for the production of such light forms. The light forms of the present invention can easily be configured to have symmetric and asymmetric other than round cross sections. Moreover, the production steps are minimized resulting in substantial cost savings. It is contemplated that claddings, for example, with a round interior and a square exterior, square interior and square exterior or asymmetric exterior can easily be extruded in one step using polyacrylamides, polycarbonates, polymethacrylates, polyacrylates or polyadipates resins.

In accordance with an important aspect of the invention, the suitable cladding material, including polyacrylamides, polycarbonates, polymethacrylates, polyacrylates or polyadipates among other resins is free of halogens such as chlorine, fluorine and bromine. It is within the scope of the present invention, nonetheless, to use halogenated resins such as polyacrylamides, polycarbonates, polymethacrylates, polyacrylates, polyadipates. Conversely silicone polymers, although, more costly than other the resins mentioned above, proved suitable. The silicone resins, similarly, may be free of halogens or halogenated.

Known conventional processes such as casting, extrusion, vacuum forming, blow, slush, rotational and injection molding among other processes proved suitable in the production of the cladding of the present invention. For instance, a poly(methyl methacrylate) tubing with a round, symmetrical cross section, formed using conventional extrusion process proved suitable. Precautions were exercised to assure that the poly(methyl methacrylate) tubing wall was free of any foreign particles and or any degradation. As may be expected, a comparative tubing made by casting proved to show less absorption or scattering of light. Under proper conditions, cylindrical tubings containing the appropriate core materials, when illuminated provided light forms similar to traditional light guides or optical fibers.

Polyadipates with refractive indices of 1.5-1.6, relatively low cost, low specific gravity, flexibility at low temperatures, resistance to ozone and oxygen with other desirable characteristics proved to be exceptionally suitable as cladding materials. However, polyadipates are hygroscopic and hydrophilic, and in applications where the light form may be exposed to high moisture or used under water, the moisture reaching the core causes cloudiness hindering light transmission and emission. According to an aspect of the present invention, the use of a water-soluble liquids, oligomers or polymers alleviates this problem. As a result of the water solubility of the core medium, water molecules reaching the core are readily absorbed by the core material without causing cloudiness. Among the suitable core materials compatible with polyadipates (e.g., caprolactone based polyurethane) are hydrogels (i.e. poly(hydroxyethyl methacrylate)), polymers such as poly glycols with a molecular weight of 100-4000 and higher and refractive indices in the range of 1.44-1.46, water soluble oligomers and liquids such as water-soluble silicone oils with refractive indices of 1.40-1.47. Light-emitting forms made using the combination as disclosed and placed at relatively very high humidity and underwater for long periods of time (over 60 days) did not exhibit any deterioration of light transmission and emission. The same qualities were observed at extreme temperatures (e.g. below −20° C. above 60° C.).

Other Desirable Cladding Resins and/or Precursors for the Production of Desirable Resins Are:

Aromatic polyesters

Saturated polyesters(Polycyclohexylenedimethylene terephthalate, Polyethylene terephthalate, Polyalkylene terephthalates)

Unsaturated polyesters

Polyols (e.g. Polybutylene adipate glycol, Polyethylene-propylene adipate glycol, Polypropylene glycol, Polyallyl diglycol carbonate)

Polypropylene adipate

Polysilane (e.g. Polyacryloxysilane)

Polysiloxane (e.g. Polydimethylsiloxane, Polycarboranesiloxane)

Polytetrahydrofuran

Vinyl polymers (e.g. Polyvinyl acetate, Polyvinyl alcohol, Polyvinyl butyral)

Polyarylates

As with any other light transmitting embodiment, the core materials of the present invention offer the optimum result when the material is free of physical defects such as bubbles or impurities that may cause adverse scattering, or impurities that would cause light absorption. The core/clad interface presents another important factor to consider. For relatively longer light forms, the light scattering at the interface must be minimized; while for shorter lengths where more dispersion of light may be desirable, the interface may be possibly manipulated to achieve the desired effect.

The process for making the embodiments of the present invention can be fully automated and continuous. For example, the light-transmitting core may continuously be inserted into tubing as the tubing is being formed through a conventional extrusion process. Downstream, the tubing containing the core material can be pinched off, cut and a light source placed in position and sealed.

Conventional methods for placing and sealing can easily be used. Multiple layered tubing, or tubing with appropriate coatings can be used according to the present invention. However, the refractive index, transparency, degree of purity of the multi-layered container or coating among other factors must be considered in order to not adversely affect the spirit of the invention. Conventional processes may be used for applying a coating or coatings, such as, spray coating, dipping, and vacuum coating among others. UV curing coatings can potentially be used. The coating can be applied onto the container prior or after the core has been included. For multi-layered containers, in order to eliminate any chance of foreign elements to permeate into the container, a multi-layered container including a barrier layer may be used. The barrier layer may actually be a tie-layer, or be the layer in contact with the core or light transmitting medium or be the outermost layer of the container.

It is within the scope of the present invention to use cross-linked cladding materials.

It is within the scope of the present invention to use processing methods to continuously form the cladding and the core. For instance, it is contemplated that:
1) a polymer mass to form the core is co-extruded simultaneously with a cladding, using techniques known in the art for simultaneous co-extrusion of two polymers;
2) a radiation curing mixture is introduced through a cross-head into a tubing while being formed, the curing mixture is then polymerized in situ by radiation curing;
3) the curing mixture in Paragraph 2) above, may consist of monomer(s), oligomers(s), pre-polymer(s) or any mixture thereof and the appropriate photo-initiator(s);
4) a greasy material to form the core is introduced through a cross-head into a tubing while being formed;
5) an RTV (room-temperature vulcanizing) mass is introduced through a cross-head into a tubing while being formed; the curing mixture is then polymerized at room temperature in situ.

Alternative methods of making the light-emitting forms of the present invention will be obvious from these examples to those skilled in the art.

### EXAMPLE 1

An ether-based polyurethane tubing, 100 cm in length, with 6.5 mm inside diameter and 8.0 mm outside diameter was filled with a very viscous, water clear, purified oil supplied by STE Oil Company of San Marcos, Tex. One Agilent LED (HLMT-PG00), San Jose, Calif. was inserted at each end of the tube. LEDs were immersed and were in direct contact with the oil. When LEDs were lit, the light-emitting device glowed uniformly along its entire length and had an aura very similar to neon, although not as bright. The polyurethane tubing's refractive index was reported at 1.54 and the oil's refractive index was lower.

### EXAMPLE 2

Example 1 was repeated with a longer length tubing (e.g. 200 cm). The device as expected did not exhibit a uniform glow throughout the entire length of the device and was not as bright as Example 1.

### EXAMPLE 3

To overcome the shortcoming of Example 2, Example 2 was repeated except Omron red 2MDR01-85R1A LEDs, Schaumburg, Ill., with higher intensity and a narrower viewing angle as compared to Agilent LED (HLMT-PG00) were used. The light-emitting device glowed uniformly along its entire length and had an aura very similar to neon, although not as bright.

### EXAMPLE 4

Example 1 was repeated except that 3.0 mm inside diameter, 4.0 mm outside diameter tubing from the same supplier was fitted with a Kingbright 3 mm W7104 SEC/H LEDs, Walnut, Calif. The light-emitting device glowed uniformly along its entire length and had an aura very similar to neon, although not as bright.

### EXAMPLE 5

Cast poly(methyl methacrylate) tubing with 14 mm inside diameter and 17 mm outside diameter was filled with low molecular weight poly glycol. Due to the rigidity of the tubing, it was difficult to create a sealed device. Nonetheless, a red Luxeon™ Emitter supplied by Lumileds Lighting, LLC, San Jose, Calif. was placed at one end and activated. The lighting device glowed uniformly and had substantial aura. The uniform look was somewhat blemished because of the scratches on the surface of the poly(methyl methacrylate).

### EXAMPLE 6

An ester-based polyurethane tubing was filled at room temperature with a RTV GE Silicone 615 (e.g., a two part compound, normally mixed in a one-to-one ratio by volume) supplied by GE Sealant and Adhesives, Fairfield, Conn. and allowed to vulcanize at room temperature over several hours. One Omron red 2MDR01-85R1A red LED was placed at each end of the tube. The light-emitting device glowed uniformly along its entire length and had an aura up to length of 1.2 meter. Attempts to prepare longer lighting devices resulted in substantial loss of light (e.g., the lighting devices looked very bright at each end with substantially lower brightness in the center). The polyurethane tubing's refractive index was reported at 1.54 and the cured GE Silicone 615 refractive index was reported at 1.41.

### EXAMPLE 7

An aromatic, ester-based polyurethane tubing was filled with a UV curable mixture containing 3% by weight photo-initiator supplied by Albemarle Corporation, Bridgeport, N.J., plugged at one end, pressurized to 20 psi and passed at a rate of 1 meter per minute under a Fusion radiation curing system. A continuous length of over 100 meters was prepared in this manner. One Omron 2MDR01-85R1A red LED was placed at each end of the tube. The light-emitting device glowed uniformly along its entire length and had an aura up to length of 1.0 meter. Attempts to prepare longer lighting devices resulted in substantial loss of light (e.g., the lighting devices looked very bright at each end with substantially lower brightness in the center). The polyurethane tubing's refractive index was reported at 1.54 and the cured polymer at 1.43.

The light-emitting form discussed above may be combined with other components to form an illumination system. In particular, the light form may be combined with one or more illumination assemblies to form an illumination system. In particular, one embodiment for supplying light into the containers of the present invention or into the light transmitting medium is an illumination assembly which contains any combination of LEDs, light directing component(s), reflector and/or refractor component(s), switching device(s), logic component(s), control(s) and energy component(s), or any other components attributing to the transmission and dispersion of light. Such illumination assembly as alluded to above can be incorporated on one or both ends of a light form of the present invention, to form an illumination device. Various formats for the incorporation of the illumination assembly are contemplated. In one embodiment, the light element may have an extended collimating device in contact with the core another embodiment, in which the container is formed as a tube, the illumination assembly may be inserted into one or both end of the tube to create a device resembling neon.

It is understood that the characteristics of illumination assembly such as the illumination assembly size, the illumination assembly physical configuration, focusing subassemblies, the angle of projected light (e.g. viewing angle), light element clustering (e.g. cluster of LEDs arranged sparsely on a substrate, in comparison to a cluster of the same number of LEDs arranged more compactly), collimation of projected light, light frequency, color mixing among other factors, profoundly affect the light transmission and dispersion, and subsequently, the glow and aura of light-emitting form of the present invention.

Many light sources such as halogen, xenon and high intensity discharge lamps can be used in the illumination devices of the present invention. However, LEDs are particularly desirable, because of monochromaticity, low voltage, energy efficiency, ruggedness, compact size, ease of collimation and focusing among other attributes. The combination of LEDs and the present invention can be used in different manners to create efficient light forms and systems with uniform glow and substantial aura.

### INDUSTRIAL APPLICABILITY

The applications of the light forms and systems disclosed are primarily in signage, displays, architectural, healthcare, transportation among others.

An elongated lighting system of the present invention with appropriate light sources such as LEDs has a “neon look. Tubular neon lights are widely used in the sign, display and illumination markets. The present invention offers other advantages such as energy efficiency, color changing, digital addressability, flexibility in design, biocompatibility, resistance to vibration and shock, and ease of mass production, among many others apparent to those in the art.

Many modifications and variations of the present invention will be apparent to those skilled in the art in light of the above teachings. Thus, it is to be understood that, within the scope of the appended claims, the invention may be practiced otherwise than as specifically described above.

1. A light-emitting form comprising:
an elongated light guide having a first end and a second end; and
a light source that sheds light into the first end of the light guide;
wherein the light guide further comprises:
a tubular light-transmitting container consisting essentially of a substantially amorphous polymer with a first index of refraction, the container having a first open end, a second open end, an inside surface and an outside surface; and
an elongated light-transmitting core with a second index of refraction lower than said first index of refraction, the core having a first end and a second end, the core being within the container and optically connected to the inside surface thereof;
whereby the light guide exhibits an aura, wherein the outside surface of the container illuminates its surroundings and appears to glow.

2. The light-emitting form of claim 1 further comprising means for sealing the first open end of the light guide and means for sealing the second open end of the light guide, whereby the light guide is adapted to contain a core of liquid.

3. The light-emitting form of claim 2 wherein the core consists essentially of a liquid comprising a salt solution.

4. The light-emitting form of claim 2 wherein the core consists essentially of a liquid comprising an oil.

5. The light-emitting form of claim 2 wherein the core consists essentially of a liquid comprising a water-soluble polymer in solution.

6. The light-emitting form of claim 2 wherein the core consists essentially of a liquid comprising a polyglycol.

7. The light-emitting form of claim 2 wherein the core consists essentially of a liquid comprising a solution of a low molecular weight organic compound in organic solvent.

8. The light-emitting form of claim 2 wherein the core consists essentially of a liquid comprising a solution of a low molecular weight inorganic compound in inorganic solvent.

9. The light-emitting form of claim 2 wherein the core consists essentially of a liquid comprising an oligomer in solution.

10. The light-emitting form of claim 2 wherein the means for sealing the second end of the light guide comprises a solid wall integral with the container.

11. The light-emitting form of claim 9 wherein the means for sealing the first end of the light guide comprises a light source embedded as a plug in the first end of the container.

12. The light-emitting form of claim 1 wherein the container consists essentially of a solid comprising a cross-linked polymer.

13. The light-emitting form of-claim 1 wherein the container consists essentially of a solid comprising a hydrogel.

14. The light-emitting form of claim 1 wherein the container consists essentially of a solid comprising a thermoplastic polymer.

15. The light-emitting form of claim 1 wherein the container consists essentially of a solid comprising a cross-linked polymer.

16. The light-emitting form of claim 1 wherein the container consists essentially of a solid comprising a thermoset polymer.

17. The light-emitting form of claim 1 wherein the container consists essentially of a solid comprising a halogenated hydrocarbon.

18. The light-emitting form of claim 1 wherein the light guide is substantially cylindrical in shape:

19. The light-emitting form of claim 1 wherein the cross section of the inside surface of the container has a shape different from the cross section of the outside surface of the container.

20. The light-emitting form of claim 1 wherein the light source comprises a plurality of light-emitting elements at the first end of the light guide that shed light into the first end of the light guide.

21. The light-emitting form of claim 1 further comprising a second light source that sheds light into second end of the light guide.

22. The light-emitting form of claim 1 wherein the light source comprises a light-emitting diode.

23. A light-emitting form comprising:
a container consisting essentially of a solid tubular element comprising a substantially amorphous acrylic polymer having a first index of refraction, having an inside surface of about 14 mm diameter, an outside surface of about 17 mm diameter, a first end, and a second solid end;
a core consisting essentially of a liquid comprising poly glycol having a second index of refraction lower than said first index of refraction, the core being within the container and optically connected to the inside surface thereof; and
a light source consisting essentially of a light-emitting diode, sealingly embedded in the first end of the container and optically connected to the core into which it sheds light,
whereby the light-emitting form exhibits an aura, wherein the outside surface of the container illuminates its surroundings and appears to glow.

24. A light-emitting form comprising:
a container consisting essentially of a solid comprising a substantially amorphous polyurethane having a first index of refraction, having an inside surface of about 6.5 mm diameter, an outside surface of about 8 mm diameter, a first'solid end, and a second solid end;
a core consisting essentially of a liquid comprising purified oil having a second index of refraction that is lower than said first index of refraction, the core being within the container and optically connected to the inside surface thereof; and
a light source comprising a light-emitting diode sealingly embedded in the first end of the container and optically connected to the core into which it sheds light.

25. The light-emitting form of claim 23 wherein the inside surface of the container has a diameter of about 3 mm and the outside surface of the container has a diameter of about 4 mm.

26. The light-emitting form of claim 1 wherein the inside surface of the container has a diameter of about 3 mm and the outside surface of the container has a diameter of about 4 mm.

27. The light-emitting form of claim 1 wherein the inside surface of the container has a diameter of about 6.5 mm and the outside surface of the container has a diameter of about 8 mm.

28. The light-emitting form of claim 1 wherein the inside surface of the container has a diameter of about 14 mm and the outside surface of the container has a diameter of about 17 mm.

29. The light-emitting form of claim 1 wherein the inside surface of the container has a diameter of about 3 mm and the outside surface of the container has a diameter of about 4 mm.

30. The light-emitting form of claim 1 wherein the inside surface of the container has a first diameter and the outside surface of the container has a second diameter wherein the second diameter is from about 5 percent to about 30 percent larger than the first diameter.

31. The light-emitting form of claim 1 wherein the inside surface of the container has a first diameter and the outside surface of the container has a second diameter wherein the second diameter is from about 20 percent to about 25 percent larger than the first diameter.

32. The light-emitting form of claim 1 wherein the container has an index of refraction of about 1.55 and the core has an index of refraction of about 1.45.

33. The light-emitting form of claim 1 wherein the container has a first index of refraction and the core has a second index of refraction wherein the first index of refraction is from about 2 percent to about 15 percent greater than the first index of refraction.

34. A method of making a light-emitting form of claim 1 comprising the steps of purifying and de-airing the liquid core medium, followed by pouring into the container liquid, prepolymers or syrupy polymers of a material selected from the group consisting of methyl methacrylates, 2-ethylhexyl methacrylates, styrene, and 2-ethylhexyl acrylate.

35. A method of making a light-emitting form of claim 1 by first combing pre-polymer with appropriate amount of initiator, injecting this mixture into the container followed by curing.

36. A method of making a light-emitting form of claim 11 by first combing pre-polymer of 2-ethylhexyl methacrylate, in very pure form with appropriate initiator and injecting into a suitable cladding (i.e. polyadipate cladding), and further curing at a higher temperature in a water bath, resulting in a satisfactory light-emitting form.

37. A method of making a light-emitting form of claim 1 with a-cross-linked core, wherein prepolymer of methyl methacrylate is combined with 0.1 to 1% by weight of diethylene dimethylmethacrylate, as a cross linker, followed by placement in a container of polyadipate.

38. A method of making a light-emitting form of claim 1 wherein core is polymerized in the container, first mixing n-butyl methacrylate with an initiator under pressure in a closed system, then putting the polymer mass, while kept molten, under negative pressure, for a time sufficient to remove unreacted initiator, monomer and other volatiles, then injecting the molten mass into a polyurethane tubing at high temperature.

39. A method of making a light-emitting form of claim 1 continuously and fully automated by continuously inserting the light-transmitting core into the container tubing as the tubing is being

40. An elongated light guide having a first end and a second end, comprising:
a tubular light-transmitting container consisting essentially of a substantially amorphous polymer with a first index of refraction, the container having a first open end, a second open end, an inside surface and an outside surface; and
an elongated light-transmitting core with a second index of refraction lower than said first index of refraction, the core having a first end and;a second end, the core being within the container and optically connected to the inside surface thereof;
whereby the light guide exhibits an aura, wherein the outside surface of the container illuminates its surroundings and appears to glow, when illuminated by light impinging on its first end.

41. The light-emitting form of claim 1 wherein the container has a crystallinity of less than 1 per cent by weight.

42. The light-emitting form of claim 1 wherein the container has a crystallinity of less than 0.1 per cent by weight.
